(19) United States
(12) Patent Application Publication
(10) Pub. No.: US 2019/0323570 A1
(43) Pub. Date: Oct. 24, 2019

(54) DISC BRAKE

(71) Applicant: TOYOTA JIDOSHA KABUSHIKI KAISHA, Toyota-shi (JP)

(72) Inventors: Teruaki Aoyama, Toyota-shi (JP); Akihiro Kenju, Miyoshi-shi (JP); Akira Mitsuoka, Toyota-shi (JP)

(73) Assignee: TOYOTA JIDOSHA KABUSHIKI KAISHA, Toyota-shi (JP)

(21) Appl. No.: 16/390,829

(22) Filed: Apr. 22, 2019

(30) Foreign Application Priority Data
Apr. 23, 2018 (JP) 2018-082176

(51) Int. Cl. F16D 65/00; F16D 55/226; B60R 16/03; F16D 65/18

(52) U.S. Cl. CPC F16D 65/0081; F16D 55/226; F16D 2055/0037; F16D 65/18; B60R 16/03

(57) ABSTRACT

In a disc brake in which an actuator of an electric parking brake is attached to a caliper, the actuator is protected. The caliper includes: a pair of brake pads and to give rotation braking force to a disc rotor; a piston to move forward or backward such that the pair of brake pads and is pressed against or separated from the disc rotor; and a feed screw mechanism to convert rotation power output from the actuator into forward or backward propulsive force of the piston. The actuator includes a housing to house an electric motor and a speed reduction mechanism that decelerates rotation power generated by the electric motor at a predetermined ratio to transmit it into the feed screw mechanism. A protector that covers the actuator is detachably fixed to the caliper.

### CROSS-REFERENCE TO RELATED APPLICATIONS

The present application claims priority under 35 U.S.C. § 119(a) to Japanese Patent Application No. 2018-82176, filed on Apr. 23, 2018. The contents of this application are incorporated herein by reference in its entirety.

### TECHNICAL FIELD

The present invention relates to a disc brake in which an actuator of an electric parking brake is attached to a caliper.

### BACKGROUND ART

For example, Patent Document 1 describes a configuration in which a caliper of a disc brake of a vehicle includes an electric parking brake mechanism.

The parking brake mechanism is configured to: make a vehicle a brake state by causing a pair of brake pads to sandwich a disc rotor due to a piston moved forward by a drive unit including an electric motor and a reduction gear; and after that, maintain the brake state even when a power supply to the electric motor is stopped.

### PRIOR ART DOCUMENT

### Patent Document

[Patent Document 1] JP 2016-056848 A

### SUMMARY OF THE INVENTION

### Problem to be Solved by the Invention

In Patent document 1, a housing in which the electric motor and the reduction gear of the drive unit are housed is exposed outside. Thus, when the vehicle is traveling, a flying object (for example, a stone or a falling object on the road) may directly strike against the housing. Here, there is a room for improvement.

In consideration of the above circumstances, an object of the present invention is to protect an actuator of an electric parking brake, which is attached to a caliper of a disc brake.

### Means for Solving the Problem

The present invention provides a disc brake in which an actuator of an electric parking brake is attached to a caliper. The caliper includes: a pair of brake pads configured to give rotation braking force to a disc rotor; a piston configured to move forward or backward such that the pair of brake pads is pressed against or is separated from the disc rotor; and a feed screw mechanism configured to convert rotation power output from the actuator into forward propulsive force or backward propulsive force of the piston. The actuator includes a housing configured to house: an electric motor that generates the rotation power; and a speed reduction mechanism that decelerates the rotation power generated by the electric motor at a predetermined ratio and transmits the decelerated rotation power into the feed screw mechanism. To the caliper, a protector that covers the actuator is detachably fixed.

In the above configuration, the actuator is covered by the protector. Thus, when the vehicle is traveling, a flying object (for example, a stone or a falling object on the road) does not strike against the electric motor and the speed reduction mechanism of the actuator.

In addition, since the protector is fixed to the caliper, even when the brake pads included in the caliper have worn out, the relative positional relationship between the protector and the actuator does not change, unlike the case in which the protector is fixed to the vehicle body side. Thus, it is possible to stably maintain a protection effect by the protector to the actuator for a long time.

Also, since the protector can be detached from the caliper, it is possible to contribute to weight reduction of the vehicle by removing the protector in the condition that the actuator is not required to be protected.

In the disc brake as described above, it is preferable that the actuator is attached to an outer surface of the caliper, and that the protector is attached to the caliper such that the protector is located further outside the actuator.

Here, the attaching position of the actuator to the caliper as well as the configuration in which the actuator is covered by the protector are defined.

In the disc brake as described above, it is preferable that the protector includes: an inflated body to entirely cover the actuator; and an outward flange provided around an opening edge of the inflated body. Also, it is preferable that attaching parts are disposed respectively at two positions of the outward flange so as to be separated from each other in a peripheral direction of the outer flange so that the attaching parts respectively make contact with predetermined positions of an outer surface of the caliper and are fixed to the predetermined positions with bolts.

Here, the specific configuration of the protector as well as the state thereof attached to the caliper are defined. With such a configuration, it is clear that the protector can be attached or detached using bolts with comparative ease.

In the disc brake as described above, it is preferable that the housing of the actuator is provided with a connector to which is coupled a harness that supplies electric power to the electric motor. Also, it is preferable that the protector is configured to also cover the connector and furthermore part of the protector is spaced apart from the housing of the actuator so that the harness is taken out to the outside.

With the above-described configuration, it is possible to protect the connector of the actuator by the protector against flying objects. In addition, it is possible to attach the protector to the caliper after coupling the harness to the connector.

### Advantageous Effect of the Invention

In a disc brake of the present invention, in which an actuator of an electric parking brake is attached to a caliper, it is possible to protect the actuator.

### BRIEF DESCRIPTION OF THE DRAWINGS

FIG. 1 is an exploded perspective view illustrating a disc brake according to an embodiment of the present invention.

FIGS. 2(a)-2(b) are cross sectional views illustrating usage conditions of the disc brake in FIG. 1. FIG. 2(a) indicates a condition before a disc pads wear out. FIG. 2(b) indicates a condition after the disc pads have worn out.

FIG. 3 is a front view illustrating the disc brake in FIG. 1, from which a disc rotor thereof is omitted.

FIG. 4 is a diagram illustrating a caliper in FIG. 3 viewed from an outer diameter side thereof.

FIG. 5 is a cross sectional view viewed along line (5)-(5) in FIG. 3.

FIG. 6 is a cross sectional view viewed along line (6)-(6) in FIG. 3.

### DESCRIPTION OF THE EMBODIMENT

Hereinafter, a preferred embodiment to carry out the present invention will be described in detail with reference to the appended drawings.

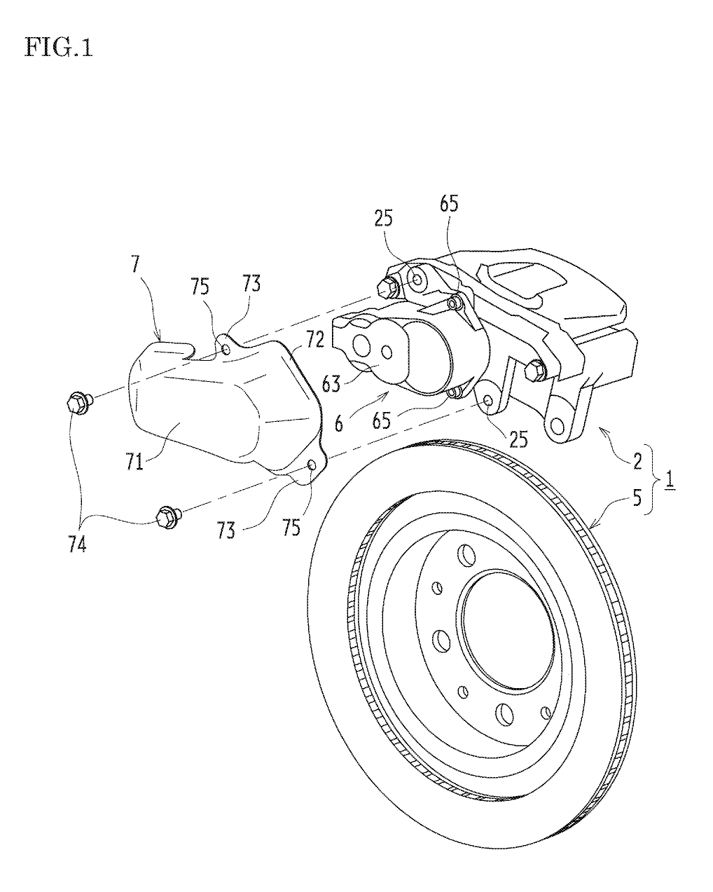

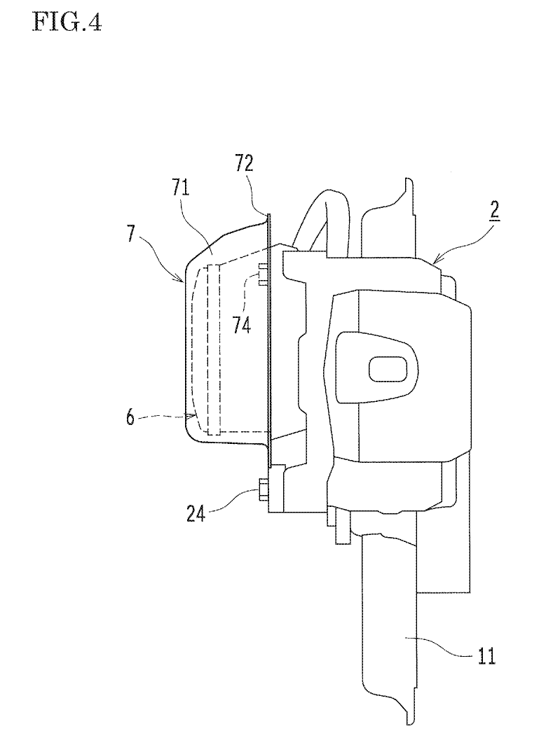

FIGS. 1 to 6 show an embodiment of the present invention. Although it is not specifically shown in Figures, a disc brake 1 in the Figures has a configuration, for example, as follows: a piston 22 is installed in a cylinder 21 of a cantilever type or a floating type caliper 2; and the piston 22 is linearly moved by hydraulic pressure such that a pair of brake pads 3 and 4 is pressed against a disc rotor 5, which generates rotation braking force of the disc rotor 5.

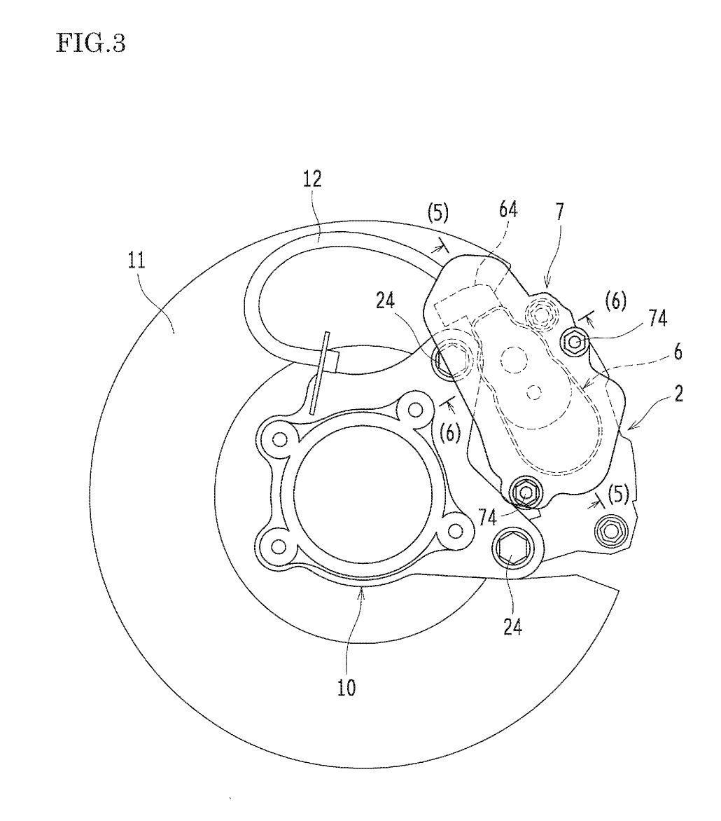

As shown in FIG. 3, the caliper 2 is fixed, by bolts 24 or the like, to a rear axle housing (an axle tube) 10 that houses a rear axle shaft (not shown).

In FIG. 3, the disc rotor 5 is omitted. A dust cover is indicated by the reference sign 11, and a hydraulic hose is indicated by the reference sign 12.

As shown in FIG. 6, the caliper 2 is provided with the cylinder 21 that houses the piston 22.

The piston 22 is moved forward and backward linearly in the cylinder 21 by a feed screw mechanism 23. The feed screw mechanism 23 is to convert rotation power input from an actuator 6 (described later) into forward propulsive force or backward propulsive force of the piston 22.

By the piston 22, the pair of brake pads 3 and 4 is pressed against the disc rotor 5.

One of the pair of brake pads 3 and 4 installed in the caliper 2 is disposed at a front edge of the piston 22. The other of the pair of brake pads 3 and 4 is disposed in the caliper 2, at a position that is spaced apart in parallel from the one of the pair of brake pads 3 and 4 so as to face the one of the pair of brake pads 3 and 4.

The actuator 6 of the electric parking brake is attached to the outer surface of the caliper 2 (i.e. the surface located outside when the caliper 2 is mounted on a vehicle).

The actuator 6 has in principle the same configuration as the publicly known configuration. In the actuator 6, an electric motor 61, a speed reduction mechanism 62 and the like are housed in a housing 63.

The electric motor 61 is to generate rotation power. The speed reduction mechanism 62 is, for example, a planetary gear mechanism that decelerates the rotation power generated by the electric motor 61 at a predetermined ratio and inputs such decelerated rotation power into the feed screw mechanism 23.

The feed screw mechanism 23 is to convert the rotation power that is generated by the electric motor 61 and decelerated by the speed reduction mechanism 62 into the forward propulsive force and the backward propulsive force of the piston 22.

In this way, the actuator 6, the feed screw mechanism 23 and the piston 22 of the caliper 2, and the brake pads 3 and 4 are operated so as to function as a parking brake. That is, the electric parking brake is a combination of the actuator 6 and the caliper 2.

The housing 63 of the actuator 6 is provided with a connector 64 to which a harness (not shown) is coupled. The harness supplies electric power to the electric motor 61.

The housing 63 is detachably fixed to the caliper 2 with bolts 65. The housing 63 is made of an appropriate synthetic resin.

A protector 7 is detachably fixed to the caliper 2 with bolts 74 in such a manner that the protector 7 entirely covers the actuator 6.

The protector 7 is made of, for example, an appropriate metal. The protector 7 has an inflated body 71 so as to entirely cover the actuator 6. An outward flange 72 is provided around an opening edge of the inflated body 71.

As shown in FIG. 1, attaching parts 73 are disposed respectively at two positions of the outward flange 72 so as to be separated from each other in the peripheral direction.

The attaching parts 73 each include a bolt insertion hole 75, through which the bolt 74 is inserted and screwed into a corresponding screw hole 25 of the caliper 2. Thus, the protector 7 is fixed to the caliper 2.

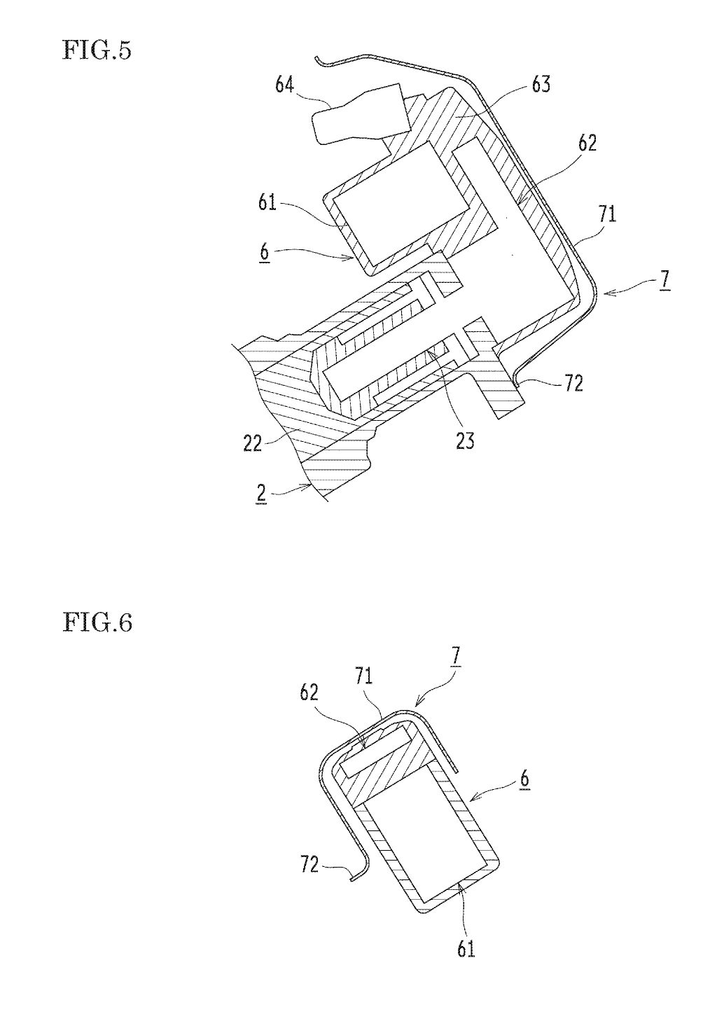

In this embodiment, as shown in FIG. 5, part of the protector 7 is spaced apart from the housing 63 of the actuator 6 so that the harness (not shown), which is coupled to the connector 64 of the actuator 6, is taken out to the outside.

In this way, the protector 7 can be attached to the caliper 2 after the harness (not shown) is coupled to the connector 64 of the actuator 6.

In the state in which the protector 7 is attached to the caliper 2, it is preferable to set the above separation distance between the protector 7 and the harness (not shown) to a value not too large.

Hereinafter, a description will be given on the operation of the parking brake in the above-described embodiment.

When a normal brake is activated by a brake operation of a driver, brake hydraulic pressure is applied to the piston 22 in the cylinder 21 of the caliper 2 by the master cylinder (not shown) through the hydraulic hose 12. Accordingly, the piston 22 is moved forward to press one of the pair of brake pads 3 and 4 against the disc rotor 5. Then, the caliper 2 is slid due to reaction force, which makes the other of the pair of brake pads 3 and 4 pressed against the disc rotor 5. Thus, the rotation braking force to the disc rotor 5 is generated.

After that, when the normal brake is released, the brake hydraulic pressure against the piston 22 is also released. Accordingly, the piston 22 is moved backward to disengage the brake pads 3 and 4 from the disc rotor 5. Thus, the rotation braking force to the disc rotor 5 is lost.

Meanwhile, when the electric parking brake is activated, the electric power is supplied to the electric motor 61 of the actuator 6 to generate the rotation power. The generated rotation power is transmitted to the piston 22 as the forward propulsive force via power transmission mechanisms (the speed reduction mechanism 62 and the feed screw mechanism 23). Thus, the piston 22 is moved forward.

In this way, similarly to the above, the pair of brake pads 3 and 4 is pressed against the disc rotor 5 by the piston 22. Thus, the rotation braking force to the disc rotor 5 is generated, which makes the disc rotor 5 incapable of rotating.

In the above-described state, even when the power supply to the electric motor 61 is stopped, the position of the piston 22 is maintained. Thus, the brake state of the disc rotor 5 is also maintained.

On the other hand, when the electric parking brake is deactivated, the reverse rotation power generated by the electric motor 61 is transmitted to the piston 22 as the backward propulsive force via the power transmission mechanisms (the speed reduction mechanism 62 and the feed screw mechanism 23). Thus, the piston 22 is moved backward.

In this way, the pair of brake pads 3 and 4 is separated respectively from the disc rotor 5, which makes the disc rotor 5 capable of rotating.

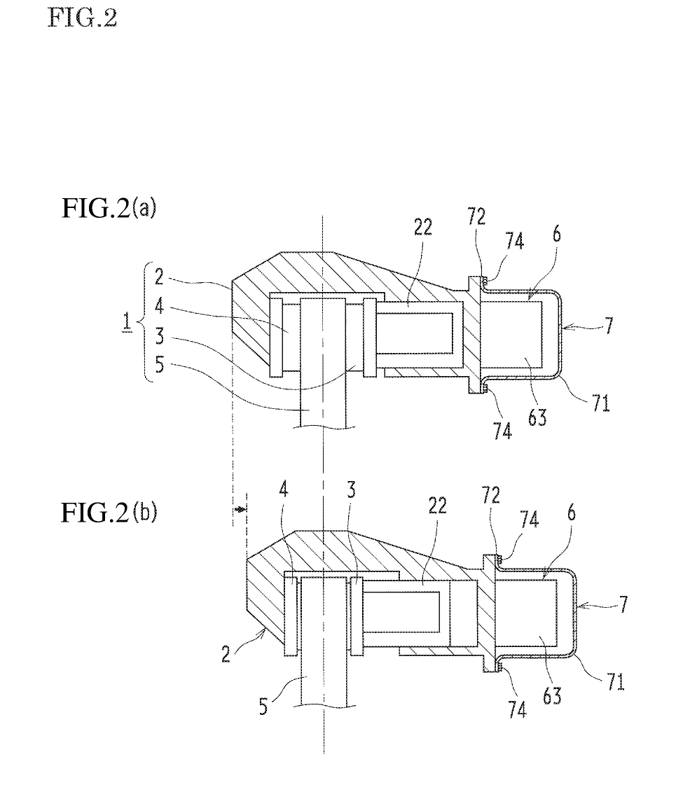

When the brake pads 3 and 4 have worn out, the position of the caliper 2 is shifted from the position indicated in FIG. 2(a) to the position indicated in FIG. 2(b). However, the relative positional relationship between the protector 7 and the actuator 6 does not change because the protector 7 is fixed to the caliper 2.

As described above, in the embodiment to which the present invention is applied, the actuator 6 of the electric parking brake is covered and protected by the protector 7. Thus, when the vehicle is traveling, the flying object (for example, a stone or a falling object on the road) does not strike against the actuator 6 (i.e. the electric motor 61 and the speed reduction mechanism 62).

In addition, since the protector 7 is fixed to the caliper 2, even when the brake pads 3 and 4 included in the caliper 2 have worn out, the relative positional relationship between the protector 7 and the actuator 6 does not change, unlike the case in which the protector 7 is fixed to the vehicle body side (for example, to the suspension or the rear axle housing 10). Thus, it is possible to stably maintain a protection effect by the protector 7 to the actuator 6 (the electric motor 61 and the speed reduction mechanism 62) for a long time.

Also, since the protector 7 can be detached from the caliper 2 by loosening the bolts 74, it is possible to contribute to weight reduction of the vehicle by removing the protector 7 in the condition that the actuator 6 (the electric motor 61 and the speed reduction mechanism 62) is not required to be protected.

The present invention is not limited to the above-described embodiment. It can be appropriately modified and changed within the scope of the appended claims and equivalency thereof.

(1) In the above-described embodiment, the present invention is exemplarily applied to the disc brake 1 having a floating type or a cantilever type caliper 2. However, the present invention is not limited thereto.

For example, the present invention may be applied to a disc brake having an opposed type caliper, although it is not shown in the Figures.

(2) In the above-described embodiment, the configuration in which the protector 7 is fixed to caliper 2 with the bolts 74 is exemplarily described. However, the present invention is not limited thereto.

For example, snap-fit clips may be used as a means for fixing the protector 7 to the caliper 2, although it is not shown in the Figures.

In this case, it is possible to easily remove the protector 7 by hands, without using the tools such as a spanner and a box-end wrench.

### INDUSTRIAL APPLICABILITY

The present invention can be suitably applied to a disc brake in which an actuator of an electric parking brake is installed in a caliper.

### REFERENCE SIGNS LIST

1 Disc brake
2 Caliper
21 Cylinder
22 Piston
23 Feed screw mechanism
24 Bolts for attaching caliper
25 Screw holes for attaching protector
3, 4 Brake pads
5 Disc rotor
6 Actuator of electric parking brake
61 Electric motor
62 Speed reduction mechanism
63 Housing
64 Connector
65 Bolts for attaching actuator
7 Protector
71 Inflated body
72 Outward flange
73 Attaching part
74 Bolts for attaching protector
75 Bolt insertion hole
10 Rear axle housing
11 Dust cover
12 Hydraulic hose

What we claim is:

1. A disc brake comprising: a caliper; and an actuator of an electric parking brake, the actuator being attached to the caliper,
wherein the caliper includes: a pair of brake pads configured to give rotation braking force to a disc rotor; a piston configured to move forward or backward such that the pair of brake pads is pressed against or is separated from the disc rotor; and a feed screw mechanism configured to convert rotation power output from the actuator into forward propulsive force or backward propulsive force of the piston,
wherein the actuator includes a housing configured to house: an electric motor that generates the rotation power; and a speed reduction mechanism that decelerates the rotation power generated by the electric motor at a predetermined ratio and transmits the decelerated rotation power into the feed screw mechanism, and
wherein a protector that covers the actuator is detachably fixed to the caliper.

2. The disc brake according to claim 1,
wherein the actuator is attached to an outer surface of the caliper, and
wherein the protector is attached to the caliper such that the protector is located further outside the actuator.

3. The disc brake according to claim 1,
wherein the protector includes: an inflated body to entirely cover the actuator; and an outward flange provided around an opening edge of the inflated body, and
wherein attaching parts are disposed respectively at two positions of the outward flange so as to be separated from each other in a peripheral direction of the outer flange so that the attaching parts respectively make contact with predetermined positions of an outer surface of the caliper and are fixed to the predetermined positions with bolts.

4. The disc brake according to claim 1,
wherein the housing of the actuator is provided with a connector to which is coupled a harness that supplies electric power to the electric motor, and
wherein the protector is configured to also cover the connector, and furthermore part of the protector is spaced apart from the housing of the actuator so that the harness is taken out to an outside.
